(19) United States
(12) Patent Application Publication
(10) Pub. No.: US 2008/0264942 A1
(43) Pub. Date: Oct. 30, 2008

(54) Induction activated cover assembly for container

(76) Inventor: Michael Tin-Kim Shek, San Mateo, CA (US)

Correspondence Address: Michael Tin-Kim Shek, P.O. Box 44-2049, Taipei, 10668, TW

(21) Appl. No.: 11/790,917

(22) Filed: Apr. 30, 2007

(51) Int. Cl. B65D 43/26; H02P 1/22

(52) U.S. Cl. 220/211; 220/230; 220/810; 318/10; 318/3

(57) ABSTRACT

A cover assembly of a container includes a first part and a second part mounted on an open top of the container, the first part includes an opening and the second part includes a through hole which is located corresponding to the opening. The second part including two sidewalls and each sidewall has a plurality of guide slots such that a plurality of plates are respectively and slidably engaged with the guide slots between the two sidewalls to open the through hole or to close the through hole. A driving unit is located on the second part and driving the plates to move along the guide slots. An induction unit is connected to a front end of the first part and includes an induction member which activates the driving unit.

### BACKGROUND OF THE INVENTION

(1) Field of the Invention

The present invention relates to an induction activated cover assembly which is composed of partly overlapped plates which are moved linearly to open and close the container by way of induction.

(2) Description of the Prior Art

A conventional induction activated cover of a container is disclosed in U.S. Pat. No. 6,812,655 and the cover is pivotably connected to the container body. A motor, a gear set and a battery are received in the space in the bottom of the container body, and a driving shaft is connected to the gear set and is connected to the cover. The cover is pivoted upward to open the container body when the motor is activated. It is obvious that the cover needs a lot of space to be pivoted to the opened position. However, if the container is used as a trashcan and put under a table, there is limited space between the cover and the top of the table, so that when the cover is inducted to open, the cover touches the top of the table before the cover is pivoted to the opened position. Furthermore, the speed of the opening of the cover is too slow because the motor an the gear set are located at a distance from the cover, the transmission force has to transfer to the cover through the driving shaft which is as long as the height of the container body.

The present invention intends to provide an induction activated cover assembly for a container such as a trashcan and the driving unit and the cover are located at the top of the trashcan, and the cover is composed of multiple plates which are moved linearly to open and close the trashcan.

### SUMMARY OF THE INVENTION

The present invention relates to a cover assembly of a container and comprises a first part and a second part which is mounted on an open top of the container. The first part has an opening which is located corresponding to a through hole of the second part. The second part includes two sidewalls and a front wall connected between the two sidewalls. Each sidewall has a plurality of guide slots defined in an inside thereof and a plurality of plates are respectively and slidably engaged with the guide slots between the two sidewalls. A driving unit is located on the second part and drives the plates to move along the guide slots. An induction unit is connected to a front end of the first part and includes an induction member which activates the driving unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the cover assembly of the present invention;

FIG. 2 is a perspective view to show the second part of the cover assembly of the present invention;

FIG. 3 is a side view to show the cover assembly of the present invention wherein the plates are moved to an end to open the through hole of the second part;

FIG. 3A shows the power supply includes a switch;

FIG. 4 is a side view to show the cover assembly of the present invention wherein the plates are expanded end to close the through hole of the second part;

FIG. 5 is a top view to show the cover assembly of the present invention;

FIG. 6 is a perspective view to show the cover assembly of the trashcan is in closed status of the present invention, and

FIG. 7 is a perspective view to show the cover assembly of the trashcan is in opened status of the present invention.

### DETAILED DESCRIPTION OF THE PREFERRED EMBODIMENT

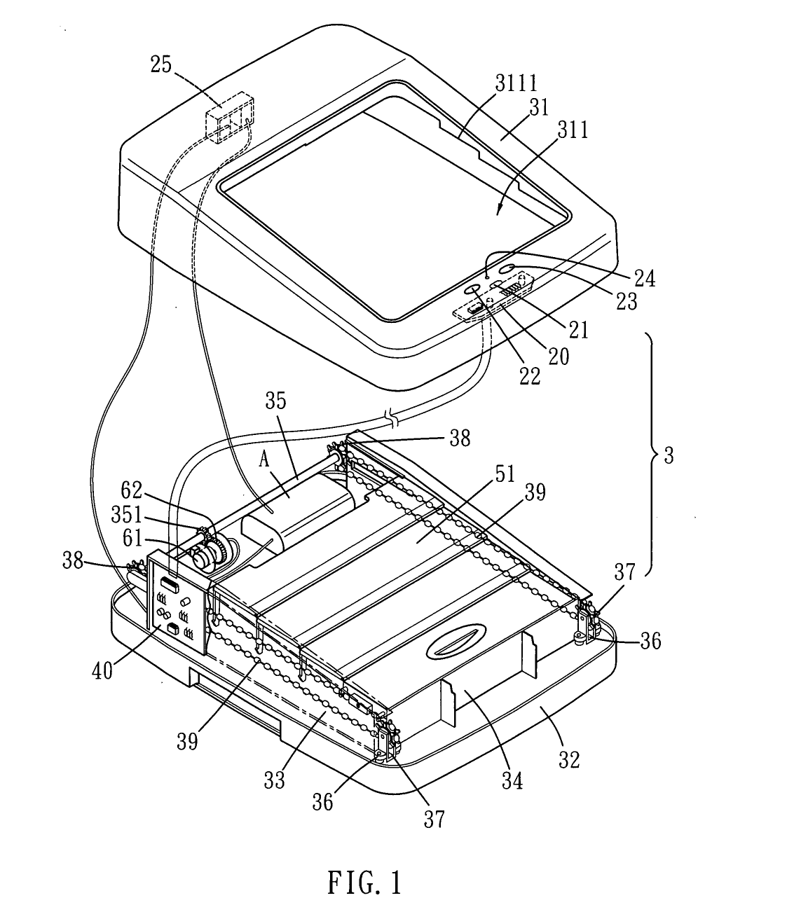

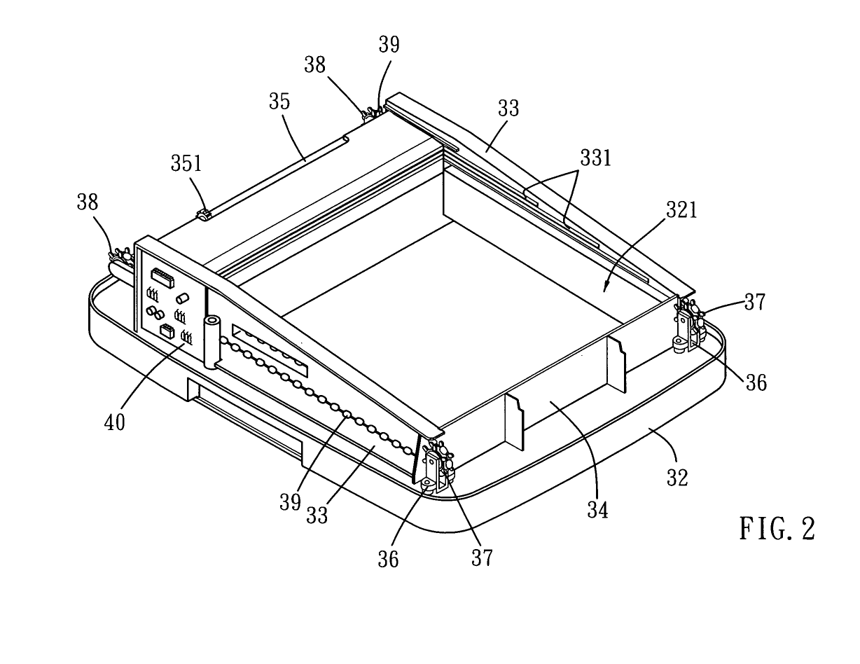

Referring to FIGS. 1 and 2, the cover assembly 3 of a container such as a trashcan of the present invention comprises a first part 31 and a second part 32 which is mounted on an open top of the container. The first part 31 includes an opening 311 a plurality of stepped edges 3111 are defined in two insides of the opening 311 of the first part 31. An induction unit 20 is connected to a front end of the first part 31 and includes an induction member 21 which activates the driving unit connected to the second part 32. The induction unit 20 includes a manual “ON” switch 22 and a manual “OFF” switch 23, an indication light 24 is located between the manual “ON” switch 22 and the manual “OFF” switch 23.

The second part 32 has a through hole 321 which is located corresponding to the opening 311. The second part 32 includes two sidewalls 33 and a front wall 34 is connected between the two sidewalls 33. Each sidewall 33 has a plurality of guide slots 331 defined in an inside thereof and a plurality of plates 51 are respectively and slidably engaged with the guide slots 331 between the two sidewalls 33. A top of two ends of each of the plates 51 is slidably in contact with the stepped edges 3111.

The driving unit is located on the second part 32 and is able to drive the plates 51 to move along the guide slots 331. Two front wheels 37 are located on two respective front ends of the two sidewalls 33 by two U-shaped frames 36 and tow rear wheels 38 are located on tow respective rear ends of the two sidewalls 33 by two U-shaped frames 36. Two respective transmission members 39 are respectively driven by the front and rear wheels 37, 38. One of the plates 51 is driven by the transmission members 39. A shaft 35 is located at a rear end of the second part 32 and connected between the two rear wheels 38. The driving unit further includes a motor 61 and a gear set 62 driven by the motor 61. The shaft 35 includes a gear 351 mounted thereto which is engaged with the gear set 62. A power supply “A” is connected to the second part 32 and electrically connected to the control unit 4 and the motor 61. A switch 25 is connected to the rear end of the firs part 31. A control unit 40 is connected one of the two sidewalls 33 and electrically connected with the induction unit 20, the switch 25 and the power supply “A” The power supply “A” can be a battery and a cover “B” is used to position the battery.

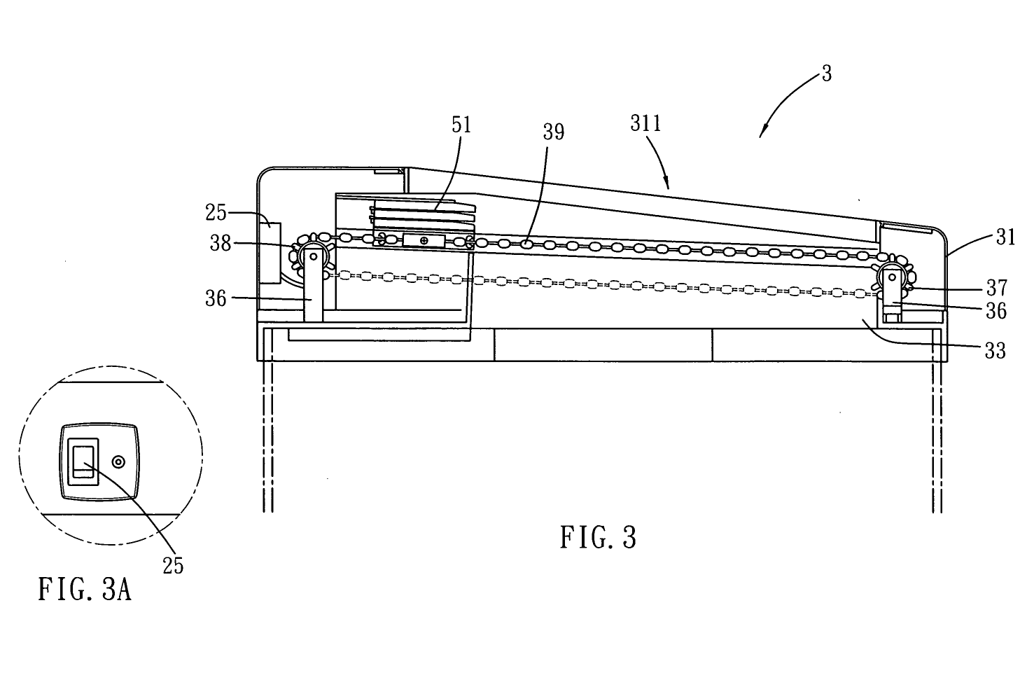

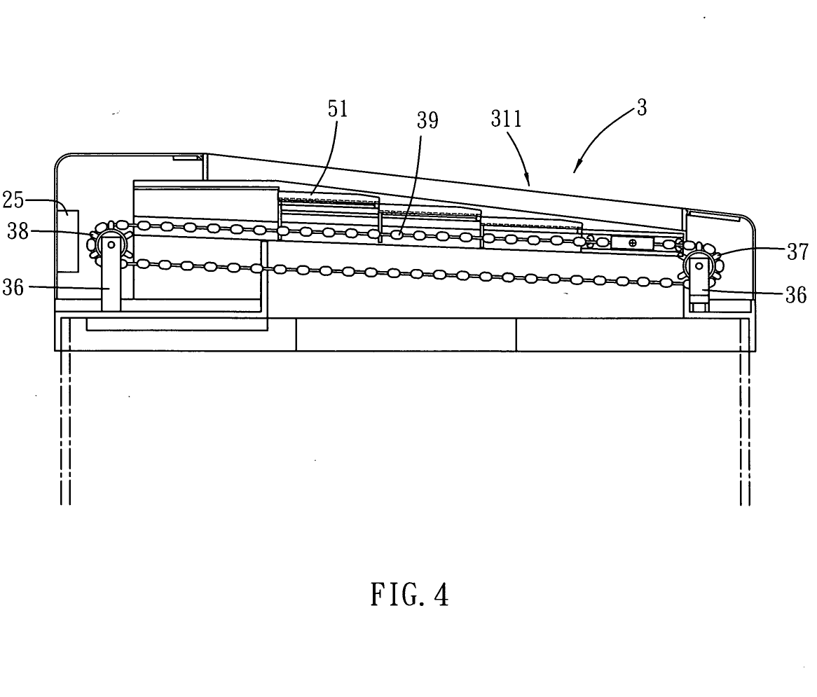

As shown in FIGS. 3 to 7, each of the plates 51 includes a hook portion 511 and a groove 512 which includes a closed end. The hook portion 511 of a first plate 51 is slidably engaged with the groove 512 of a second plate 51 and stopped by the closed end so as to drive the second plate 51 moved with the first plate 51.

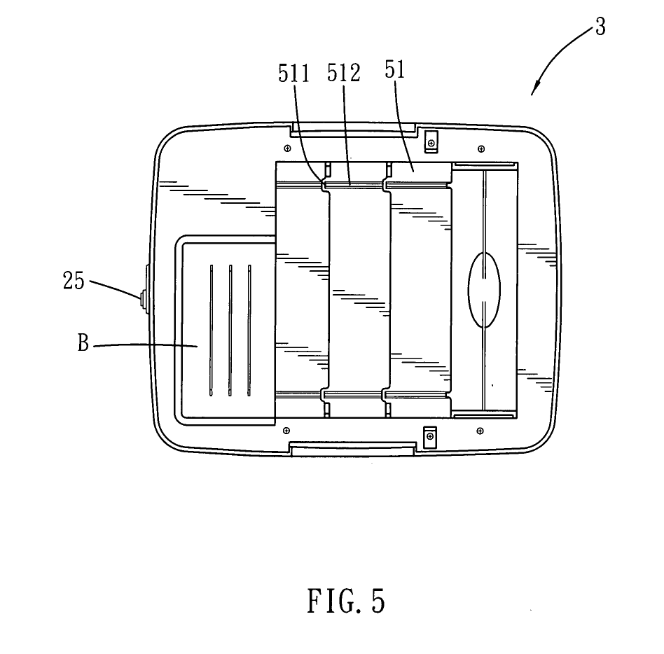

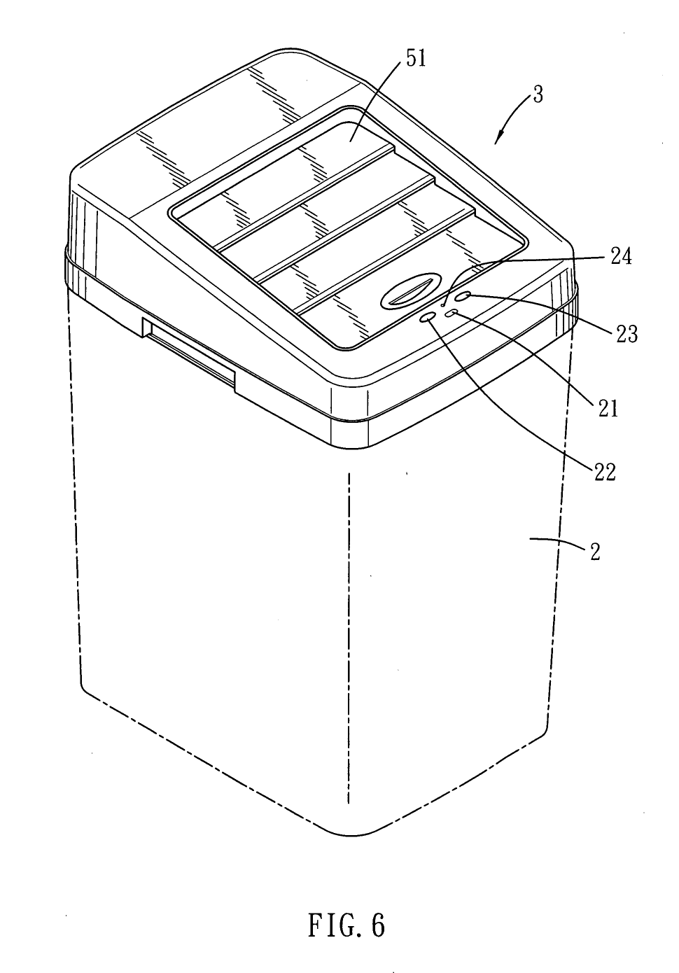

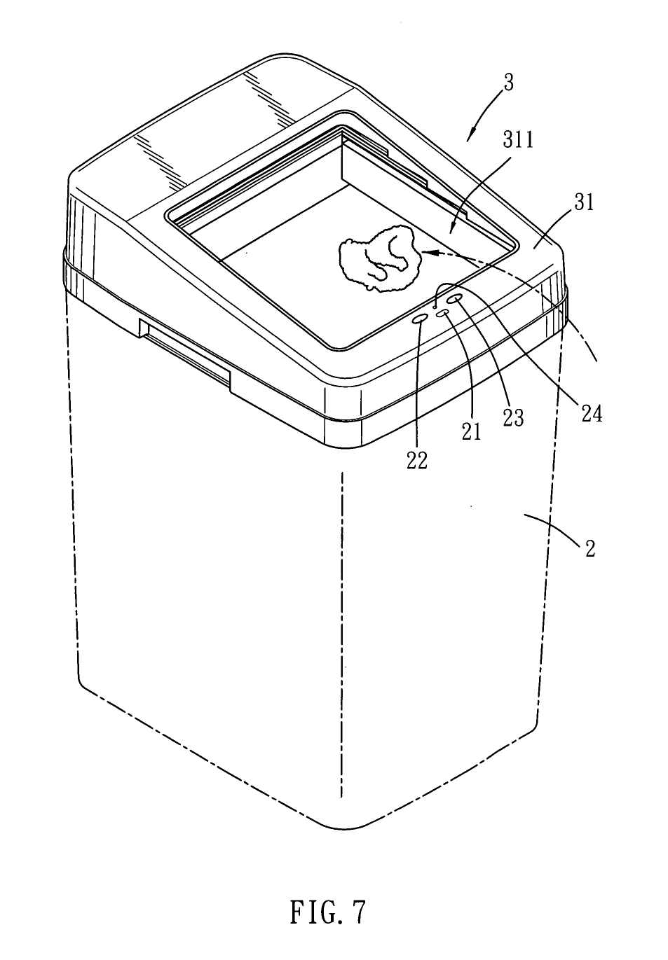

The plates 51 closes the through hole 321 of the second part 32 when the plates 51 are respectively engaged with the guide slots 331 as shown in FIGS. 5 and 6. When the user's hand approaches the induction unit 20, the induction member 21 senses the hand and sends a signal to the control unit 40 which activates the motor 61 to rotate the shaft 35 and the leading plate 51 is pulled toward the rear end of the second part 32 so that the rest of the plates 51 are pushed to the closed position as shown in FIGS. 3 and 7. The plates 51 move quickly so that the user does not need to wait to through the garbage into the container 2 (trashcan).

The plates 51 move linearly so that the space between the cover assembly and an underside of the top of a table does not affect the operation of the cover assembly. The cover assembly is an independent combination so that any container 2 can be cooperated with the cover assembly.

While we have shown and described the embodiment in accordance with the present invention, it should be clear to those skilled in the art that further embodiments may be made without departing from the scope of the present invention.

What is claimed is:

1. A cover assembly of a container, comprising:
a first part and a second part which is adapted to mount on an open top of the container, the first part having an opening and the second part having a through hole which is located corresponding to the opening, the second part including two sidewalls and a front wall connected between the two sidewalls, each sidewall having a plurality of guide slots defined in an inside thereof and a plurality of plates respectively and slidably engaged with the guide slots between the two sidewalls, and
a driving unit located on the second part and driving the plates to move along the guide slots, an induction unit connected to a front end of the first part and including an induction member which activates the driving unit.

2. The cover assembly as claimed in claim 1, wherein a plurality of stepped edges are defined in two insides of the opening of the first part and a top of two ends of each of the plates are slidably in contact with the stepped edges, two front wheels are located on two respective front ends of the two sidewalls and tow rear wheels are located on tow respective rear ends of the two sidewalls, two respective transmission members are respectively driven by the front and rear wheels, a shaft is located at a rear end of the second part and connected between the two rear wheels, a control unit is connected one of the two sidewalls.

3. The cover assembly as claimed in claim 1, wherein one of the plates is driven by the transmission members.

4. The cover assembly as claimed in claim 2, wherein the driving unit includes a motor and a gear set driven by the motor, the shaft includes a gear mounted thereto which is engaged with the gear set.

5. The cover assembly as claimed in claim 1, wherein a power supply is connected to the second part and electrically connected to the control unit and the motor.

6. The cover assembly as claimed in claim 2, wherein each of the front and rear wheels is installed to a U-shaped frame.

7. The cover assembly as claimed in claim 1, wherein each of the plates includes a hook portion and a groove which includes a closed end, the hook portion of a first plate is slidably engaged with the groove of a second plate and stopped by the closed end so as to drive the second plate moved with the first plate.

8. The cover assembly as claimed in claim 1, wherein the induction unit includes a manual “ON” switch and a manual “OFF” switch.
